(19) United States
(12) Patent Application Publication
(10) Pub. No.: US 2013/0138477 A1
(43) Pub. Date: May 30, 2013

(54) Systems and Methods for Improved Server-Implemented Price Comparisons, Price Alerts and Discounts

(71) Applicants: Robert Wilkins, Peterborough, NH (US); Matthew Sheppard, Bow, NH (US); Andrew Curioso, Nashua, NH (US)

(72) Inventors: Robert Wilkins, Peterborough, NH (US); Matthew Sheppard, Bow, NH (US); Andrew Curioso, Nashua, NH (US)

(73) Assignee: myVBO, LLC, Milford, NH (US)

(21) Appl. No.: 13/814,594

(22) PCT Filed: Aug. 12, 2011
(86) PCT No.: PCT/US2011/047543

§ 371 Date: Feb. 6, 2013

Related U.S. Application Data
(60) Provisional application No. 61/373,514, filed on Aug. 13, 2010.

(51) Int. Cl. G06Q 30/06

(52) U.S. Cl. CPC G06Q 30/0629
USPC 705/7.31; 705/26.64; 705/7.29

(57) ABSTRACT

The present invention relates to systems and methods for providing improved server-implemented product price purchasing options based on unique product identifiers, display charts comparing average vendor prices, forecasts of best purchasing times, automated price updates, target price notifications, easy to use checkout methods for multiple retail sites and local vendor product displays.

### CROSS-REFERENCE TO RELATED APPLICATIONS

This application claims priority to U.S. provisional application No. 61/373,514, filed Aug. 13, 2010, and incorporates the entire contents thereof herein by reference.

### FIELD OF THE INVENTION

The present invention is generally related to systems and methods for providing improved server-implemented product price comparisons and optimized consumer purchasing and vendor product selling opportunities.

### BACKGROUND OF THE INVENTION

The Internet comprises a vast number of computers and computer networks that are interconnected through communication links. The interconnected computers exchange information using various services, such as electronic mail, Gopher, and the World Wide Web (“Web”). The Internet has become an essential component for every business, organization and institution, and has lead to massive amounts of information being placed on the Internet for retail purchases, including product purchasing information, product discount information and gift registries sites. The Internet is a venue of choice for many people for purchasing products, finding product sales, for competitive vendor pricing and for gift registry shopping.

In the last few years several technologies have been introduced in an effort to further improve consumer experiences to find the best online product deals, online sales, retail store inventory and quick purchasing options. In some instances, these technologies further refined the ability to sort products by including price range criteria, brand name criteria and to sort by preferred retail stores. Examples of online websites with improved consumer purchasing opportunities include Pricegrabber®, Amazon.com®, Nextag®. While each of these sites include easier purchasing opportunities for consumers, none of these sites give consumers automatic product price feedback based on product Uniform Product Codes (UPC), European Article Numbers (EAN), model numbers, or manufacturer part numbers (MPN) to obtain the best product deals immediately. These sites further do not allow a user to see product price trends over time, to make informed decisions on the best purchasing time frames for a specific product. Finally, these sites do not provide immediate pop-up product deals such as a small window displaying competitive prices on a user's computer screen during a product search, with, for instance, a closest competitor product shown on a pop-up of a user's browser, a list of lowest product price deals searched narrowly by a unique product identifier such as the UPC, EAN, MPN or model number, a list of local retailers based on a user's location obtained from GPS or the users Internet Protocol (IP) address with the same or similar products, including local retailers who may not otherwise have an Internet site, or allowing users to suggest a lower price and immediately accepting that lower price based on a negotiated lowest sale price or group sale prices, or improved checkout methods for ease of use by the consumer, each necessary improvement which the inventors have developed herein to provide improved systems and methods for server-implemented product purchases.

It is therefore a need to provide improved server-implemented product purchasing opportunities to consumers and selling opportunities to vendors.

### SUMMARY OF THE INVENTION

Embodiments of the present invention provide a system and method for automated online product prices and optimized consumer and vendor purchasing and selling opportunities. Briefly described, one embodiment of the invention, among others includes providing a downloadable price comparison tool, collecting a unique product identifier, such as a UPC, EAN, manufacturer part, or model number based on a user's search on a shopping site for a specific product, searching for one or more retail stores selling a product with the unique product identifier and providing a pop-up display on the user's computer screen with one or more vendor product prices. In accordance with the embodiment described, a user can search any major vendor site, such as Amazon.com®, Best Buy® or Target® in search of products and the downloadable pricing tool will collect unique product identifiers based on the user's specific product searches and pop-up a menu on the user's browser, thereby presenting lower priced retail opportunities for the same or similar products for a user to link to and review. In addition, the unique product identifier search may further provide a chart of the prior day's, week's, month's or year's price points for a user, so that a user can make a further decision on the best purchasing time for a desired product.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are meant to clearly illustrate the principles of the present invention. Moreover, in the drawings, like reference numerals designate corresponding parts throughout the several views.

FIG. 1 is a flowchart of a method for managing product purchases in accordance with a first embodiment of the present invention.

FIG. 2 is an example of a pop-up price alert tool from a user's browser in accordance with a second exemplary embodiment of the present invention.

FIG. 3 is an example of a price history graph for managing product purchases in accordance with a third exemplary embodiment of the present invention.

FIG. 4 is an example of a checkout page for managing multiple product purchases in accordance with a fourth exemplary embodiment of the present invention.

FIG. 5 is a flowchart of a method for managing product purchases in accordance with a fifth exemplary embodiment of the present invention.

### DETAILED DESCRIPTION OF THE INVENTION

In the following detailed description of the invention, reference is made to the accompanying drawings, which form a part hereof, and which is shown by way of illustration of specific exemplary embodiments in which the invention may be practiced. These embodiments are described in sufficient detail to enable those skilled in the art to practice the invention, but other embodiments may be utilized and logical and other changes may be made without departing from the scope of the present invention. The following detailed description is, therefore, not to be taken in a limiting sense.

In the following description, numerous specific details are set forth to provide a thorough understanding of the invention. However, it is understood that the invention may be practiced without these specific details. In other instances, well-known steps, tools and techniques known to one of ordinary skill in the art have not been shown in detail in order not to obscure the invention. Referring to the figures, it is possible to see the various major elements constituting the methods and systems of the present invention.

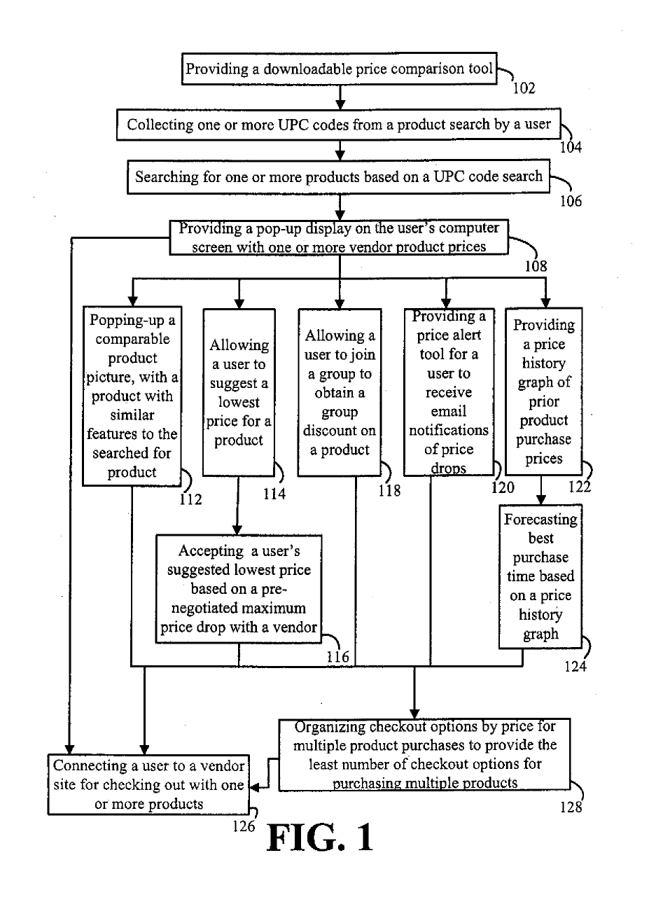

In a first exemplary embodiment of the present invention, as shown in FIG. 1, a method for improving server-implemented product purchases is described including the steps of: providing a downloadable price comparison tool, step 102, collecting a uniform product code “UPC” code based on a user's specific product search, step 104, searching for one or more vendor's selling a product with the UPC code, step 106, and providing a pop-up display on the user's computer screen with one or more vendor product prices, step 108. In accordance with the first exemplary embodiment, a user can easily search any item on the Internet, by searching for specific products on shopping sites, such as Best Buy, Target and Amazon.com®. When a user clicks a product to review, the UPC code is searched using the pricing tool in accordance with the present invention. In other embodiments, the UPC-A, UPC-E ISBN, EAN, ASIN, manufacture part number, product description, product title, product keyword or words may also be searched to locate products using the pricing tool in accordance with the present invention. The pop-up display described in step 108 is designed to work with specific search sites, such as Amazon.com, and to pop-up a display of competitive products when a user line to or clicks a product of interest, thereby narrowly tailoring their search to a specific product of interest. In accordance with this step, the user is assured that they will have the opportunity to see the best price deals from retailers on a given day, in an easy to see pop-up menu on the user's computer screen for the exact product that the user was searching for. In addition, the downloadable price comparison tool will also include local products in the search results, basing the local products on a global positioning search of a user's location and providing a user with more product options. In addition, in a next step 112 of popping-up a comparable product picture, major competitor products are shown with comparable product features, thereby providing a user with increased and possibly unknown brands to purchase with features similar to the desired and searched for product. In accordance with this step, the method described provides a means for optimizing vendor selling opportunities to a consumer, and improved vendor marketing presence in today's competitive economy, while, at the same time, providing a consumer with more informed and diverse product purchasing options. In yet another step in the first embodiment of the present invention of allowing a user to suggest a lowest price for a product, step 114, the downloadable pricing tool may have a preset discount range accepted by one or more retail vendors, so that in a next step 116 the pricing tool may automatically accept the user's suggested lowest price and proceed to checkout. In accordance with this step a vendor can maximize their selling potential and increase their competitive edge to guarantee the lowest price offerings for online purchases. In yet a further step 118 of providing group discounts in the pop-up menu described, a user may join a negotiated group discount, so that, for instance, a discount on product purchase price is received once fifty or more people have joined the group to purchase one or more similar products, or alternatively, the system can negotiate a discount after a group of interested user's is obtained at a discounted price, thereby providing vendor's with immediate selling opportunities at discounted rates. In accordance with step 118, a vendor benefits by increasing the number of selling opportunities and the user benefits by receiving product discounts once a group discount criteria is met.

In yet another step 120 of providing a price alert tool on product price drops, a user can receive a notification when a product is being offered at a user's desired price term. In the first embodiment, the notification is an email notification, while in other embodiments the notification is a text message, mobile push notification or phone message. In addition, in accordance with the first embodiment, a further step 122 of providing a price history graph of prior product purchase prices allows a user to make informed decisions on best purchasing times, and in accordance with this step 122, the method further includes the step of forecasting a best purchasing times based on the price history graph, step 124. The price history graph in accordance with the first embodiment of the present invention shows the price of products for the preceding three-month period, however in other embodiments the price history graph may review the price of products for several days, weeks, months, over the preceding year or more, or any combination thereof.

In yet another step 126 in accordance with the first embodiment of the present invention of connecting a user to a vendor site for checking out with one or more products, a method is provided for a user to checkout with one or more vendor products from the pop-up display. In addition, in yet a further step 128 of organizing checkout options by price for multiple product purchases, a user can choose the least number of checkout options for the user's convenience. By organizing checkout options, a consumer may choose to spend a little bit more money for single transaction checkouts for the consumer's convenience.

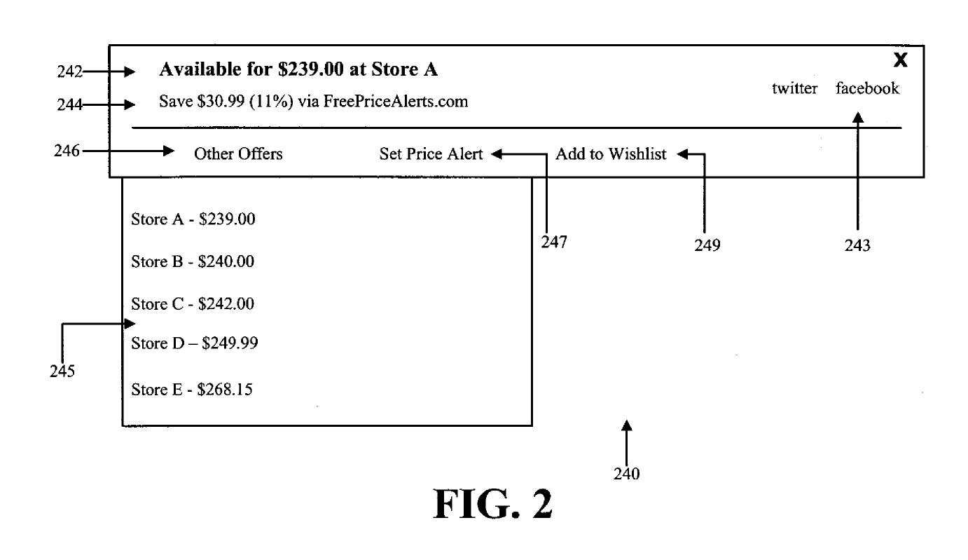

In accordance with the first exemplary embodiment shown in FIG. 1, the downloadable price comparison tool described in step 102 is further described herein. In accordance with the first exemplary embodiment, the downloadable price comparison tool is able to determine what product the user is looking for on a web page, by parsing through the HTML. The downloadable price comparison tool looks at the search terms from a user and pulls up a product description, and other information about the product including UPC, ISBN, EAN or manufacture part number and sales price once a user has clicked on a product of interest, and the results are then sent back to the price comparison tool servers. The information obtained from the user is matched up amongst resellers who sell the product, and the results are then sent back to the user. Based on the results, the price comparison tool will pop up a price alert, telling the user which vendor has the cheapest product and provide a link to the product. The price comparison tool will also pop up a green check mark if the product that the consumer is currently looking at is the cheapest product. In accordance with the first exemplary embodiment the user can click on the green check mark to make the pop up show other vendors who have the product, add the product to a wish list, share the product on a social media site or a gift registry, set a price alert or indicate that they are interested in a group price discount, improvements which are further described in FIGS. 2, 3 and 4.

In the second exemplary embodiment shown in FIG. 2, a pop-up display is shown in accordance with a second exemplary embodiment, which will come up when a product is searched using the downloadable price comparison tool in accordance with the present invention. In the second exemplary embodiment shown, the pop-up display 240 is rectangular in shape and pop's out on the left hand side of a user's browser screen during a product search, so that a user can see several competitively priced vendor purchasing opportunities. In accordance with this second exemplary embodiment a best priced vendor 242 is displayed and a price savings 244 is shown in the pop-up display 240 so that a user can immediately see competitive pricing opportunities and share the competitive prices through social media networks such as Facebook® and Twitter® 243. As alternative options an other offers link, 246, is provided in the pop-up display 240 so that a user can view a list of vendor's and vendor product prices 245, giving a user the opportunity to make a decision based on desired vendor and best pricing opportunities. In accordance with the second exemplary embodiment the user further has an opportunity to click the set a price alert link, 247, in the pop-up display 240, to set a desired price to purchase a product and to receive a notification when the price point has hit the desired point or to add the product to wish list 249 for future purchase or addition to a gift registry. In accordance with step 247 the notification is an email notification, while in other embodiments a text message, mobile push notification or phone message are other preferred notification methods.

Similarly, the pop-up display 240 may also have a competitive product picture with features similar to the user's searched for product to provide other product options to a user. In accordance with this embodiment the vendor display 242 will show a competitive product brand and the price. As an example, if a user is searching for a brand name camera, a similar other brand name camera will pop-up on the user's screen, so that a user can see competitively priced and similarly featured products while shopping online. This tool further provides vendors with an opportunity to increase their product marketing opportunities to consumers through directed product advertising based on online consumer product search terms. In yet another features of the second embodiment, the pop-up display 240 may have an additional window for a user to suggest a desired price point for immediate consideration by a vendor. In accordance with this embodiment, the downloadable price comparison tool will have a pre-negotiated maximum price drop allowance with a given vendor, so that the downloadable price comparison tool can immediately accept a user's suggested retail price in accordance with a vendor's desired maximum sale price. In accordance with this embodiment of the present invention a vendor is able to maximize their potential online purchases to consumers looking for best product deals, while consumers at the same time save money on their transactions.

In yet another feature of the second embodiment, a group discount link may be provided in the pop-up display 240. In accordance with this feature, a vendor can offer a user a group discount purchase price by allowing the user to join a list of consumer's choosing to purchase a product at a group discount rate. In accordance with this embodiment, a user will receive an email notification when a vendor has exceeded the maximum required group members to offer a discounted product price. In addition, in accordance with this embodiment, the system and methods described will provide a reverse discount opportunity, wherein the system collects a desired price drop from several users, and then approaches one or more vendors to obtain the desired price drop once several users have requested a similar price drop. In accordance with this embodiment, the vendor's will obtain increased selling opportunities for larger quantities product sales using the unique features of the present invention to collect, retrieve and share data from multiple users looking for similar products.

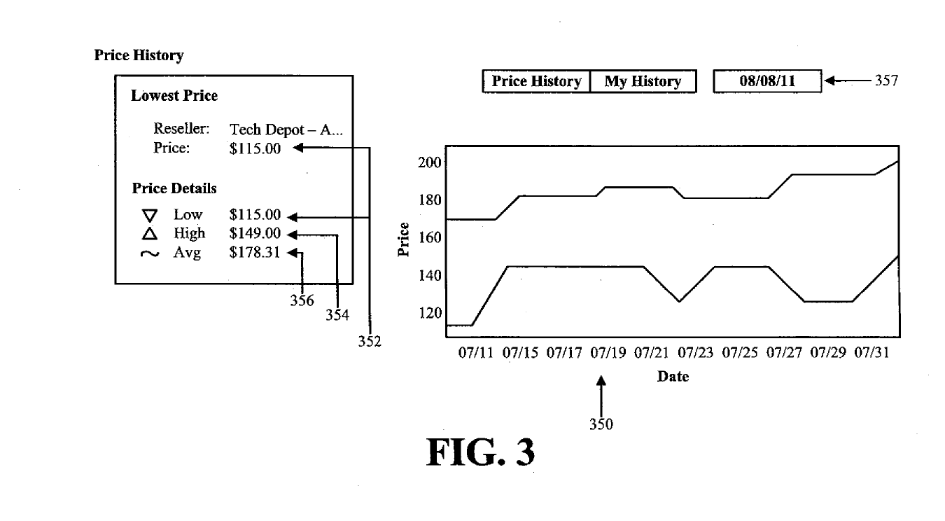

FIG. 3 shows further details of the price history graphs described in FIG. 1, in accordance with a third exemplary embodiment of the present invention. In accordance with the third exemplary embodiment, a price history graph 350 is shown with a low price point 352, an average price point 356 and a high price point 354 of a product over the course of a relevant period of time, in this case three weeks. For instance, the price history graph shown in FIG. 3 shows the price of a chosen television product each week, so that a user can choose a best purchasing time to purchase the television. In accordance with this embodiment, colored lines are used to delineate high price points and low price points of a product, shown as black lines in FIG. 3. In addition, as shown in FIG. 3, the price history graph allows a user to set a date 357 to review any date range on the price history graph. In accordance with the third exemplary embodiment, a forecast of the best purchasing time is calculated based on prior week, month or year trends, so that a user can time their purchases in accordance with best price deals. In accordance with the third exemplary embodiment, in order to obtain accurate forecasting and price history graph information, extreme low and extreme high prices are removed from the price history graph 350, in this case, prices deviating more than eighty-percent from the median product price point are removed from the price history graph 350.

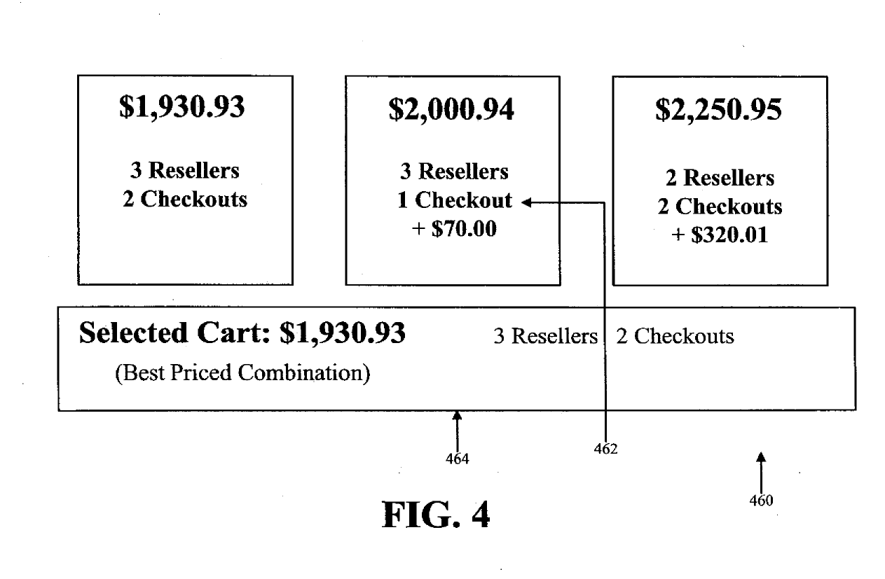

The invention described in accordance with the first embodiment of the present invention further described improved checkout methods for multiple product purchases, which are further described in the fourth exemplary embodiment shown in FIG. 4. FIG. 4 shows multiple checkout options 460 provided to a user based on the number of resellers and the number of checkouts required. In this embodiment, a tab with the least number of checkout options 462 is provided so that a user has the option of checking out the least number of times with the price differential shown for single checkout options versus multiple checkout options. A user further has the option of checking out at the lowest price combination 464, where the user may have to use more than one checkout method but will obtain the lowest price for multiple product purchases. In accordance with this embodiment, a user may save time by checking out with a single checkout transaction, or can save money on multiple product purchases by choosing the least expensive checkout price combination.

The methods described in accordance with the first embodiment of the present invention further included the step of providing local product vendors in the pop-up display described. In accordance with the embodiment described, any available method such as a user's Global Positional System or Internet Protocol Address global positioning system can be used to detect a user's location and provide feedback on local vendors with products of interest to a user. In this embodiment, the user can save time and money by locating products in their local area, so that gasoline expenses and shipping expenses can be avoided. iPad, iPhone, Android, Blackberry, cell-phones and any portable device with internet access are examples of devices that can use satellite communication to provide feedback on local vendors incorporated into the downloadable price comparison tool in accordance with the present invention, for user's looking for best product deals locally. The method described further allows local vendor's that have no specific web-based presence to have their products made available to user's searching the web for best product deals, in a quick and easy to see pop-up on the user's screen. The method described thus furthers a need for small businesses to compete with larger companies in advertising and price competition.

In yet another fifth embodiment of the present invention a system for improving server-implemented product purchases is described including a price comparison tool, and;

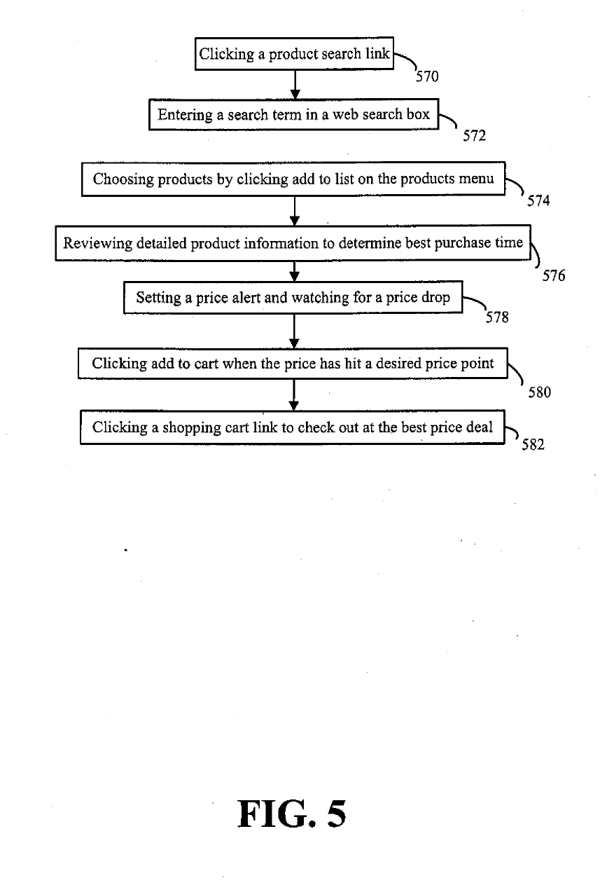

an automated price updating tool, wherein multiple vendor prices of one or more products are automatically updated on a user's product wish list. In accordance with this embodiment a user can authenticate themselves on a product management website and add products to a wish list. In accordance with the embodiment described, the automated price updating system will update the most current vendor prices of products on the user's wish list, so that a user can purchase the products on any given day at the best prices. The system described continuously scans the web to provide best price offerings to users, saving users time in searching for the best product deals. FIG. 5 shows several steps for managing product purchases in accordance with the fifth exemplary embodiment of the present invention.

In a first step shown in FIG. 5 of clicking a product search link, step 570, in the user's toolbar and entering a search term in a web search box, step 572 and pressing search, a user can initiate a search request in accordance with the fifth exemplary embodiment. The automated price updating system in accordance with the present invention will then search thousands of databases and list products meeting a user's search criteria, sorting the products by resellers from lowest price to highest price. In a next step 574, a user may choose products to purchase or products to manage by clicking add to list on the products menu. A user may then go to the manage products list in the products menu, step 576 and at least the following information will be made available to the user: a detailed description of the products, the retail UPC code, a price history graph showing the high, low and average price points of the product in the market over time, and a list of the resellers of the product. The manage products list may also include rankings on resellers, suggestions on upcoming price drops and market trends, and suggestions on product quality and consumer favorites. At this stage the user has the option to continue to manage the products and wait for a price drop at a later time, or to purchase an item from a reseller by clicking a reseller web link in the reseller menu. In the embodiment described a product alert link will be available for consumers watching for a price drop for a later purchase, step 578, so that a user can immediately checkout with a product when the desired price point is reached. In other embodiments, price alerts may be sent and synchronized with any number of personal accounts including but not limited to, e-mail and phone applications, such as an iPhone or an iPad application, for ease-of-review by a consumer. In accordance with the fifth exemplary embodiment, a user is assured to make informed decisions on product purchases, and confirm that the user is receiving the best deal in an acceptable time frame. In accordance with this embodiment, a user will click an add to cart link for each product that the user wishes to purchase, step 580 and then click a shopping cart link to review a user's product elections, step 582, to check quantities of products ordered and to confirm the resellers chosen for each product. In another unique feature of the present invention, the product pricing tool will provide checkout preference tabs for ease-of-use by a consumer, allowing the user to see tabs summarizing the total price points of the products being purchased, accompanied by a notation of the number of resellers required for checking out and the number of check-outs required. In accordance with this method, a user has an option to click each product individually to check out, or to choose a packaged check-out plan that offers the fewest number of check-out options, for instance if two or more products are from the same resellers, at a price point that is acceptable to the user. In a next step 584, a user may elect from the users shopping cart a desired method of checking out multiple products using one or more of the options described above, in accordance with the user's time and financial requirements or for single product checkouts. The system in accordance the embodiment described may also be incorporated into an improved gift registry for users, as further described below.

In accordance with the fifth embodiment described, a user can add products to a gift registry and share the gift registry with friends, family and other invitees. In accordance with this embodiment, the gift registry can be sent as an email link for others to view the gift registry contents. In accordance with the fifth exemplary embodiment of the present invention, an automated product pricing tool is downloaded onto the shared gift registry so that each user can open the gift registry and view the products and competitive price points for each product on the gift registry and check out from the gift registry with a vendor of choice at the price point indicated. In accordance with this embodiment, the improved gift registry serves several purposes for ease of use of each user, including but not limited to the benefits listed below:
1. The gift registry allows users to search for the best deals on product prices from multiple retail sites, as opposed to simply listing products available at one retail site. Currently most gift registries apply to products at a single retail store, thereby limiting user's purchasing and pricing options.
2. As a second benefit, a gift registry user can tag or mark a gift of choice and set a desired price point for purchasing the product. In accordance with the embodiment described, a user will receive a notification when one or more retail sites are offering a product at the user's desired price point.
3. Third the user can checkout directly from any one of multiple retail sites at any given time, with a direct link to a vendor site offering a gift registry product at a desired price point.

In accordance with the fifth embodiment of the present invention, the system for providing an improved gift registry may further include an automated removal tool for removing gifts already purchased from a gift registry. The removal tool further provides information so that user's are aware of purchases already made from a gift registry to prevent repetitive gift purchases.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A method for improving server-implemented product purchases comprising the steps of:
providing a downloadable price comparison tool;
collecting a uniform product identifier based on a user's search for a specific product;
searching for one or more vendor's selling a product with said uniform product identifier; and,
providing a pop-up display on the user's computer screen with one or more vendor product prices.

2. The method in accordance with claim 1 further comprising the step of popping up a suggested product, wherein said suggested product is chosen by said price comparison tool.

3. The method in accordance with claim 1 further comprising the step of providing a list of local products based on said user's search for a specific product.

4. The method in accordance with claim 3 further comprising the step of determining a user's location by a satellite communications tool.

5. The method in accordance with claim 1 further comprising the step of allowing said user to join a group to obtain a group discount on a product purchase.

6. The method in accordance with claim 1 further comprising the step of allowing said user to suggest a purchase price for a product.

7. The method in accordance with claim 6 further comprising the step of accepting said user's suggested lowest price based on a negotiated maximum price drop with a vendor.

8. The method in accordance with claim 1 further comprising the step of providing a price alert tool, wherein said price alert tool notifies said user of one or more product price drops.

9. The method in accordance with claim 1 further comprising the step of providing price trends of said one or more products over a period of time.

10. The method in accordance with claim 9 further comprising the step of forecasting a best purchasing time based on said price trends.

11. The method in accordance with claim 10 further comprising the step of displaying said best purchasing time to said user.

12. The method in accordance with claim 1 further comprising the step of connecting said user to a vendor site for checking out with said one or more products.

13. The method in accordance with claim 12 further comprising the step of organizing checkout options by price for multiple product purchases, wherein a user can choose the least number of checkout options for the user's convenience.

14. The method in accordance with claim 1 further comprising the step of providing local vendor products on said pop-up display.

15. The method in accordance with claim 14 further comprising the step of searching for said local vendor products based on said user's global positional system information.

16. A system for improving server-implemented product purchases comprising:
a downloadable price comparison tool, and;
an automated price updating tool, wherein multiple vendor prices of one or more products is automatically updated on a user's product wish list.

17. The system in accordance with claim 16 further comprising a price alert tool, wherein said price alert tool notifies a user when said vendor prices have reached a desired price.

18. The system in accordance with claim 16 wherein said wish list is a server-implemented gift registry.

19. A method for improving server-implemented product purchases comprising the steps of:
providing a login for a user account;
collecting a user's specific product search terms;
searching for one or more retail stores selling a product using said user's product search terms; and,
automatically updating retail price points of said products for one or more user's at each login.

20. The method in accordance with claim 19 wherein said user account is a gift registry for multiple retail stores.
